(19) United States
(12) Patent Application Publication
(10) Pub. No.: US 2006/0088635 A1
(43) Pub. Date: Apr. 27, 2006

(54) Sugar substitute and bulking agent and chocolate

(76) Inventor: Fred Goldman, Boynton Beach, FL (US)

Correspondence Address: ROBERT C. KAIN, JR., 750 SOUTHEAST THIRD AVENUE, SUITE 100, FT LAUDERDALE, FL, 333161153, US

(21) Appl. No.: 10/971,264

(22) Filed: Oct. 22, 2004

(51) Int. Cl. A23L 1/236

(52) U.S. Cl. 426/548

(57) ABSTRACT

The invention relates to a solid, low calorie, palatable sugar substitute with the following ingredients, by weight: inulin 28.3%-48.3%; polydextrose 28.0%-48.0%; maltodextrin 18.0%-28.0% 1; trace amounts of an antiagglomerant, and the balance being one or more intense sweeteners, for example, sucralose or acesulfame-K. A solid, low calorie, chocolate comestible is provided as follows: inulin 12.0-20.0%; polydextrose 15.0-25.0%; maltodextrin 2.0-8.0%; milk 0-22% dependent upon flavor (dark, milk, etc.); cocoa mass 10-50% dependent upon flavor; cocoa butter 8-25% dependent upon flavor; trace amounts of lecithin and flavor; and the balance being one or more intense sweeteners such as aspartame, acesulfame-K and sucralose.

The present invention relates to a low calorie sugar substitute and bulking agent and chocolates made with the sugar substitute and bulking agent.

### BACKGROUND OF THE INVENTION

In addition to sweetness, sugar typically provides bulk to comestible (edible products). It also reduces the water activity in baked goods by immobilizing water. It acts as a humectant to thereby affect the moisture of the finished product. It also affects the gelatinization temperature of starches during baking. Sugar plays a significant role in the structure, volume, and tenderness of the finished product.

There is a need in the marketplace for a low calorie sugar substitute that also contains a bulking agent.

High intensity sweeteners can provide the sweetness of sugar (although sometimes with a slightly different taste) but such high intensity sweeteners are many times sweeter than sugar. Therefore, only a small amount of high intensity sweetener is utilized. If a homemaker or a food manufacturer seeks to utilize high intensity sweeteners, he or she must revise all sugar containing recipes for food products. Further the bulking agent, which is part of common sugar, must be replaced in the recipe. Sugar also provides additional features such as a browning agent to food products. High intensity sweeteners lack that browning characteristic.

### SUMMARY OF THE INVENTION

The invention relates to a solid, low calorie, palatable sugar substitute with the following ingredients, by weight:

| | |
|---|---|
| inulin | 28.3%-48.3% |
| polydextrin | 28.0%-48.0% |
| maltodextrin | 18.0%-28.0% |

trace amounts of an antiagglomerant, and the balance being one or more intense sweeteners from the group of sweeteners comprising aspartame, acesulfame-K, cyclamates, saccharin, sucralose, neohesperidin, dihydrochalone, alitame, stevia sweeteners, glycyrrhizin, and thaumatin, preferably acesulfame-K 0.20% and sucralose 0.20%.

In addition, a solid, low calorie, chocolate comestible is provided as follows:

| | |
|---|---|
| inulin | 12.0-20.0% |
| polydextrin | 15.0-25.0% |
| maltodextrin | 2.0-8.0% |
| milk | 0-22% dependent upon flavor (dark, milk, etc.) |
| cocoa mass | 10-50% dependent upon flavor (dark, milk, etc.) |
| cocoa butter | 8-25% dependent upon flavor |

trace amounts of lecithin and flavor; and
and the balance being one or more intense sweeteners from the group of sweeteners comprising aspartame, acesulfame-K, cyclamates, saccharin, sucralose, neohesperidin, dihydrochalone, alitame, stevia sweeteners, glycyrrhizin, and thaumatin (preferably sucralose 0.04%).

### DETAILED DESCRIPTION OF THE PREFERRED EMBODIMENTS

Inulins are polysaccharides belonging to the polyfructan group and occur in many different plants including, for example, Jerusalem artichokes, dahlia tubers, and chicory roots. Inulin fulfills many non-sweetener functions of sugar. It is also palatable and a soluble food fiber. The goal in designing this new sugar substitute and bulking agent and low calorie chocolate candy (as well as hard candy using the sugar substitute) was to replace sugar alcohols (such as maltitol) with a substance which has a lower glycemic index. The glycemic index of a substance is the rate at which the substance is absorbed into a human body compared to glucose (rated 100).

Glycemic Index Table

| | |
|---|---|
| sugar | 65 |
| inulin | 1 |
| maltodextrin | 90 |
| polydextrin | 8 |
| acesulfame-K | 50 |
| neohesperidin | 50 |
| lecithin | 15 |
| milk | 40 |
| cocoa mass | 30 |
| cocoa butter | 10 |

It was noted by the inventor that polydextrin had a very low glycemic index. Inulin also has an extremely low glycemic index. Therefore, it was thought that a combination of inulin and polydextrin in a sugar substitute may be worthy of experimentation. However, it was discovered that substances with just inulin and polydextrin did not provide sufficient browning agent activity. The incorporation of a smaller, but still significant, amount of maltodextrin achieved the desired result.

Although the high intensity sweetener sucralose has been utilized in combination with inulin and maltodextrin and polydextrin (U.S. Pat. No. 6,423,358), the specific ranges of inulin, polydextrin, and maltodextrin are not discussed nor identified in the prior art.

Although the invention can be utilized with a number of high intensity sweeteners, such as aspartame, acesulfame-K, cyclamates, saccharin, sucralose, neohesperidin, dihydrochalone, alitame, stevia sweeteners, glycyrrhizin, thaumatin, the high intensity sweetener sucralose is preferred in the chocolate comestible and a combination of acesulfame-K and sucralose is preferred in the sugar substitute and bulking agent. Sucralose is a specially preferred in the sugar substitute because typical recipes require thermal processing (baking, retorting, extrusion, for example) and sucralose has relatively high heat stability and has high quality sensory attributes.

The sugar substitute and bulking agent composition can be produced by dry mixing, co-spray drying, co-freeze drying, a glamorization, blending, co-drying, extrusion, or by any other convenient process.

One objective of the present invention is the direct replacement of sugar in some convenient weight or volume measure and in such a manner as to require minimal or no modification of commercial or home use recipes.

The sugar substitute and bulking agent consists of the following:

| | |
|---|---|
| inulin | 38.3% (+/−10%, that is, 28.3%-48.3%) |
| polydextrin | 38% (+/−10%, nominally 28-48%) |
| maltodextrin | 23% (+/−5%, nominally 18-28%) |

trace amounts of an antiagglomerant, and the balance being one or more intense sweeteners from the group of sweeteners comprising aspartame, acesulfame-K, cyclamates, saccharin, sucralose, neohesperidin, dihydrochalone, alitame, stevia sweeteners, glycyrrhizin, and thaumatin, preferably acesulfame-K 0.20% and sucralose 0.20%.

Preferably, the sugar substitute and bulking agent has the following composition.

| | Sugar Substitute and Bulking |
|---|---|
| | Agent (% by wieght) |
| inulin | 38.30% |
| maltodextrin | 23.00% |
| polydextrin | 38.00% |
| antiagglomerant | 0.30% (preferably tricalcium phosphate) |
| acesulfame-K | 0.20% |
| sucralose | 0.20% |

The sugar substitute and bulking agent is made in the following manner. The sugar substitute and bulking agent composition can be produced by dry mixing, co-spray drying, co-freeze drying, a glamorization, blending, co-drying, extrusion, or by any other convenient process.

Experiments have been conducted with the sugar substitute. The following experiments have been made:
Four different standard cake mixes were purchased and then sugar and water added as per instructions. One sample of each mix used sugar, while the other used our sugar replacement. They were then baked as per instructions and tasted after cooling.

In all of the above examples, the product made with the sugar substitute and bulking agent was judged acceptable and a good quality relative to the sugar control.

The presence of maltodextrin in combination with high percentages by weight of inulin and polydextrin, creates sufficient browning activity such that acceptable and good quality baked goods were provided by the sugar substitute and bulking agent. Others have indicated that polydextrin does not participate in browning and is somewhat detrimental in that it is hygroscopic, which means, that it picks up moisture and makes the product sticky.

The antiagglomerant used is tricalcium phosphate. The antiagglomerant stops caking of the sugar substitute and bulking agent.

Preferably, equal amounts of acesulfame-K and sucralose (each 0.20% by weight) is preferable for the high intensity sweetener component.

One objective of the patent applicant was to create a solid, low calorie, chocolate comestible. After numerous experiments and over 25 experimental production runs of solid chocolates with different recipes and percentages of inulin, polydextrin and maltodextrin, the patent applicant identified the following solid, low calorie chocolate comestible with an acceptable taste and texture:

| | Milk Chocolate | Dark Chocolate (% by weight) |
|---|---|---|
| inulin | 15.8 | 15.9 |
| polydextrin | 20.8 | 21.9 |
| maltodextrin | 5.00 | 5.0 |
| lecithin | 0.5 | 0.5 |
| milk | 21.8 | 0 |
| cocoa mass | 10.9 | 46.7 |
| cocoa butter | 24.7 | 9.9 |
| flavor | 0.5 | 0.5 |
| sucralose | 0.04 | 0.04 |

Standard method of conching and making chocolate, only sugar in the recipe was exchanged for our sweetener.

A solid chocolate made in accordance with the previous recipe was compared against the following control chocolate:

Standard method of conching and making chocolate using sugar in the recipe.

Further, the patent applicant created the following chocolate and also compared the prepared chocolate against the control chocolate:

| | Secondary Preferred Chocolate (% by weight) |
|---|---|
| inulin | 16.50 |
| polydextrin | 20.00 |
| maltodextrin | 5.00 |
| lecithin | 0.30 |
| milk | 22.00 |
| cocoa mass | 11.00 |
| cocoa butter | 25.0 |
| flavor | 0.10 |
| acesulfame-K | 0.025 |
| sucralose | 0.02 |

Both the preferred solid chocolate and the supplementary chocolate was judged acceptable and good quality. The flavor component is known by persons of ordinary skill in the art to enhance the taste of the chocolate. Both chocolates were similar, but the preferred had a superior “mouth feel” after consumption.

The present invention provides a number of advantages, such as the following:

The chocolate and the mix provide the following advantages:
a) Low caloric level compared to existing items
b) Low Glycemic Index compared to existing items
c) Low in High Glycemic ingredients
d) No Sugar Alcohols and their laxative effects
e) Enables baking mixes to emulate the “with sugar” taste
f) Comparable in cost and cheaper than many of the existing sweetener alternatives
g) Will be available in liquid and granular format

What is claimed is:

1. A solid, low calorie, palatable sugar substitute comprising, by weight:

| | |
|---|---|
| inulin | 28-48%; |
| maltodextrin | 18-28%; |
| polydextrose | 28-48%; |

trace amounts of an antiagglomerant to reduce caking;
and the balance being one or more intense sweeteners from the group of sweeteners comprising aspartame, acesulfame-K, cyclamates, saccharin, sucralose, neohesperidin dihydrochalone, alitame, stevia sweeteners, glycyrrhizin, and thaumatin.

2. A solid, low calorie, palatable sugar substitute as claimed in claim 1 comprising, by weight:

| | |
|---|---|
| inulin | 38.30%; |
| polydextrose | 38.00%; |
| maltodextrin | 23.00%; |

said antiagglomerant being 0.30%; and
said intense sweetener being approximately equal amounts of sucralose and acesulfame-K totaling about 0.40 by weight.

3. A solid, low calorie, chocolate comestible comprising, by weight:

| | |
|---|---|
| inulin | 12-20%; |
| polydextrose | 15-25%; |
| maltodextrin | 2-8%; |
| milk | 0-22%; |
| cocoa mass | 10-50%; |
| cocoa butter | 8-25%; |

trace amounts of lecithin and flavor; and
and the balance being one or more intense sweeteners from the group of sweeteners comprising aspartame, acesulfame-K, cyclamates, saccharin, sucralose, neohesperidin dihydrochalone, alitame, stevia sweeteners, glycyrrhizin, and thaumatin.

4. A solid, low calorie, milk chocolate comestible comprising, by weight:

| | |
|---|---|
| inulin | 15.8% |
| polydextrose | 20.8% |
| maltodextrin | 5.00% |
| lecithin | 0.5% |
| milk | 21.8% |
| cocoa mass | 10.9% |
| cocoa butter | 24.7% |
| flavor | 0.5%, and |
| sucralose | 0.04%. |

5. A solid, low calorie, dark chocolate comestible comprising, by weight:

| | |
|---|---|
| inulin | 15.9% |
| polydextrose | 21.9% |
| maltodextrin | 5.0% |
| lecithin | 0.5% |
| cocoa mass | 46.7% |
| cocoa butter | 9.9% |
| flavor | 0.5%, and |
| sucralose | 0.04%. |

6. A solid, low calorie, palatable sugar substitute as claimed in claim 2 wherein said sucralose is about 0.20% by weight and said acesulfame-K is about 0.20% by weight.

7. A chocolate comestible as claimed in claim 3 wherein said intense sweetener is 0.04% sucralose by weight.

8. A method of making a comestible comprising the step of incorporating with said comestible a low calorie, palatable sugar substitute consisting of, by weight:

| | |
|---|---|
| inulin | 28-48%; |
| maltodextrin | 18-28%; |
| polydextrose | 28-48%; |

trace amounts of an antiagglomerant to reduce caking;
and the balance being one or more intense sweeteners from the group of sweeteners comprising aspartame, acesulfame-K, cyclamates, saccharin, sucralose, neohesperidin dihydrochalone, alitame, stevia sweeteners, glycyrrhizin, and thaumatin.

9. A method of making a comestible with a low calorie, palatable sugar substitute as claimed in claim 8 wherein the sugar substitute consisting of, by weight:

| | |
|---|---|
| inulin | 38.30%; |
| polydextrose | 38.00%; |
| maltodextrin | 23.00%; |

said antiagglomerant being 0.30%; and
said intense sweetener being approximately equal amounts of sucralose and acesulfame-K totaling about 0.40 by weight.

10. A method of making a comestible with a low calorie, palatable sugar substitute as claimed in claim 9 wherein the sugar substitute consisting of, by weight:

| | |
|---|---|
| inulin | 37.9% |
| polydextrose | 37.6% |
| maltodextrin | 23% |

said antiagglomerant being 0.30%; and
said intense sweetener being approximately 0.2% acesulfame-K and 1.0% neohesperidin dihydrochalone by weight.

11. A method of making a chocolate comestible comprising the step of incorporating with said chocolate comestible a low calorie, chocolate consisting of, by weight:

| | |
|---|---|
| inulin | 12-20%; |
| polydextrose | 15-25%; |
| maltodextrin | 2-8%; |
| milk | 0-22%; |
| cocoa mass | 10-50%; |
| cocoa butter | 8-25%; |

trace amounts of lecithin and flavor; and
and the balance being one or more intense sweeteners from the group of sweeteners comprising aspartame, acesulfame-K, cyclamates, saccharin, sucralose, neohesperidin dihydrochalone, alitame, stevia sweeteners, glycyrrhizin, and thaumatin.

12. A method of making a chocolate comestible as claimed in claim 11 wherein said intense sweetener is acesulfame-K, and neohesperidin dihydrochalone.

13. A method of making a chocolate comestible comprising the step of incorporating with said chocolate comestible a low calorie, milk chocolate consisting of, by weight:

| | |
|---|---|
| inulin | 15.8% |
| polydextrose | 20.8% |
| maltodextrin | 5.00% |
| lecithin | 0.5% |
| milk | 21.8% |
| cocoa mass | 10.9% |
| cocoa butter | 24.7% |
| flavor | 0.5%, and |
| sucralose | 0.04%. |

14. A method of making a chocolate comestible comprising the step of incorporating with said chocolate comestible a low calorie, dark chocolate consisting of, by weight:

| | |
|---|---|
| inulin | 15.9% |
| polydextrose | 21.9% |
| maltodextrin | 5.0% |
| lecithin | 0.5% |
| cocoa mass | 46.7% |
| cocoa butter | 9.9% |
| flavor | 0.5%, and |
| sucralose | 0.04%. |
